(19) United States
(12) Patent Application Publication
(10) Pub. No.: US 2011/0128283 A1
(43) Pub. Date: Jun. 2, 2011

(54) FILE SELECTION SYSTEM AND METHOD

(75) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng,Taipei Hsien (TW)

(21) Appl. No.: 12/760,420

(22) Filed: Apr. 14, 2010

(30) Foreign Application Priority Data
Nov. 30, 2009 (CN) 200910310699.0

(51) Int. Cl. H04N 7/18; G06T 17/00; G06F 17/30

(52) U.S. Cl. 345/420; 348/77; 707/827; 348/E07.085; 707/822; 707/E17.01

(57) ABSTRACT

A file selection system includes a display unit, a time-of-flight (TOF) camera, and a processing unit. The TOF camera captures an image, and obtains data about distances between a number of points of an individual in the image and the TOF camera. The processing unit examines the image to find a face, and build a 3D model of the face of the individual according to the face and the data about distances between the number of points of the individual and the TOF camera, and determining a gazing direction of the face and a location of the face relative to a display unit according to the 3D model of the face of the individual to obtain which area the face looks at. The processing unit further selects a media content according to the area the face looks at. The display unit displays the selected media content.

### BACKGROUND

1. Technical Field

The present disclosure relates to a file selection system and a file selection method.

2. Description of Related Art

Outdoor media, such as electronic billboards may advertise various goods and services to the public. However, most of these electronic billboards are not interactive and only statically shows a particular advertisement for a particular period of time and for large billboards only one advertisement may be displayed at the particular time. Therefore, there are room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is a block diagram of a first embodiment of a file selection system including an electronic billboard and a storage system.

FIG. 2 is a block diagram of the storage system of FIG. 1.

FIG. 3 is a schematic diagram of an individual viewing the electronic billboard of FIG. 1.

FIG. 4 is a block diagram of a second embodiment of a file selection system.

FIG. 5 is a flowchart of an exemplary embodiment of a file selection method.

### DETAILED DESCRIPTION

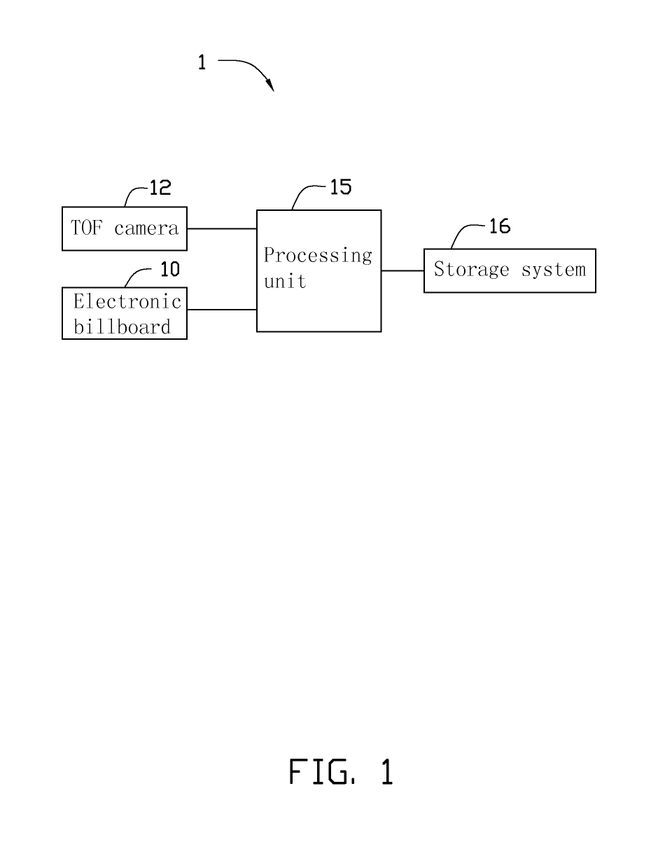

Referring to FIG. 1, a first embodiment of a file selection system 1 includes a display unit, such as an electronic billboard 10, a time-of-flight (TOF) camera 12, a processing unit 16, and a storage system 18. The file selection system 1 is operable to select different media files when an individual looks at different areas of the electronic billboard 10. The electronic billboard 10 displays media files selected by the file selection system 1.

The TOF camera 12 is disposed on the electronic billboard 10 to capture images of the immediate area. The images of the immediate area may comprise an audience of one or more individuals viewing the electronic billboard 10. The TOF camera 12 is a camera system that gathers data about the distances between audience members in the images and the TOF camera 12. When the TOF camera 12 is recording the audience, the TOF camera 12 emits signals to the audience. The signals are reflected back to the TOF camera 12 when the signals meet a feature of an audience member, such as a nose. As a result, the data about distances can be obtained according to time differences between sending and receiving the signals of the TOF camera 12.

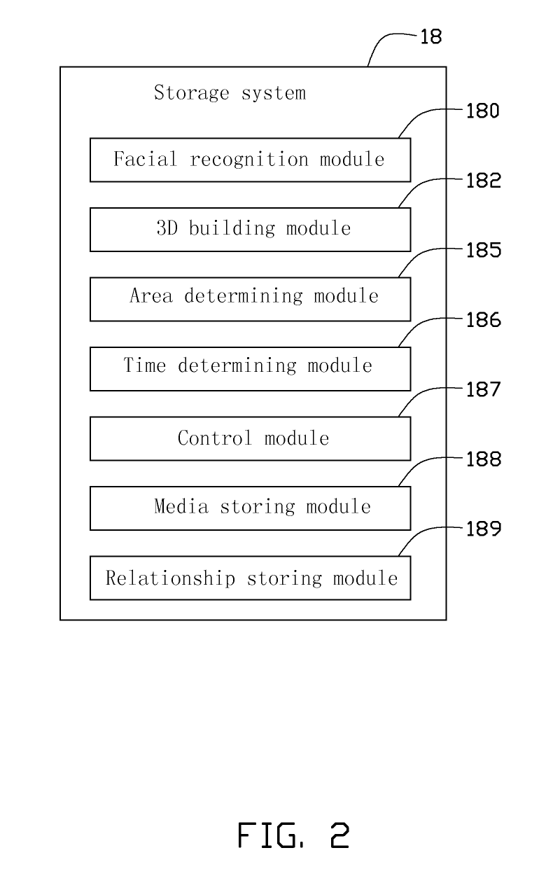

Referring to FIG. 2, the storage system 18 includes a facial recognition module 180, a three dimension (3D) building module 182, an area determining module 185, a time determining module 186, a control module 187, a media storing module 188, and a relationship storing module 189. The facial recognition module 180, the 3D building module 182, the area determining module 185, the time determining module 186, and the control module 187 may include one or more computerized instructions and are executed by the processing unit 16.

The facial recognition module 180 examines the image from the TOF camera 12 to find faces. It can be understood that the facial recognition module 180 uses well known facial recognition technology to find the faces.

The 3D model building module 182 builds a 3D model of any face found in an image and the data about distances between a plurality of points of the face and the TOF camera 12. In the embodiment, according to the data about distances between a plurality of points of the face of the individual and the TOF camera 12, the plurality of points of the found face has coordinates relative to the TOF camera 12. The 3D model building module 182 can obtain a 3D mathematical model according to the coordinates of the plurality of points and the image. The 3D mathematical model can be regarded as the 3D model of the found face of one of the individual.

The area determining module 185 determines a gazing direction of the face and a location of the face relative to the electronic billboard 10 according to the 3D model of the face, to obtain which area the face looks at. It can be understood that the area determining module 185 uses well known recognition technology to determines the gazing direction of the face.

In addition, with the data about distances between the plurality of points on the face and the TOF camera 12, the area determining module 185 may determine the location of the face relative to the electronic billboard 10, namely a vertical distance between the face and the electronic billboard 10 and a horizontal distance between a center of the electronic billboard 10 and the face. Suppose that the center of the electronic billboard 10 is regarded as an origin of a coordinate system, the area determining module 185 may obtain coordinates of areas on the billboard 10 the face looks at.

The time determining module 186 times the face gazes at an area of the electronic billboard 10. In the embodiment, the time determining module 186 starts to time when the face begins to gaze at an area of the electronic billboard 10, and stops calculating when the face begins to gaze at another area of the electronic billboard 10. As a result, the time determining module 186 can calculate the time the face gazes at an area of the electronic billboard 10.

The media storing module 188 stores a plurality of different media content, such as advertisements for a first product and a second product.

The relationship storing module 189 stores a plurality of relationships between the different areas the face looks at and the different media content. For example, advertisements for the first product may correspond to a first area the face looks at. Advertisements for the second product may correspond to a second area the face looks at.

The control module 187 determines whether the individual is interesting in the area according to the time from the time determining module 186. Upon the condition that the individual is interesting in the area, the control module 187 selects the media content according to the area, and transmits the selected media content to the electronic billboard 10. The electronic billboard 10 displays the media content in the media storing module 188 according to the control module 187.

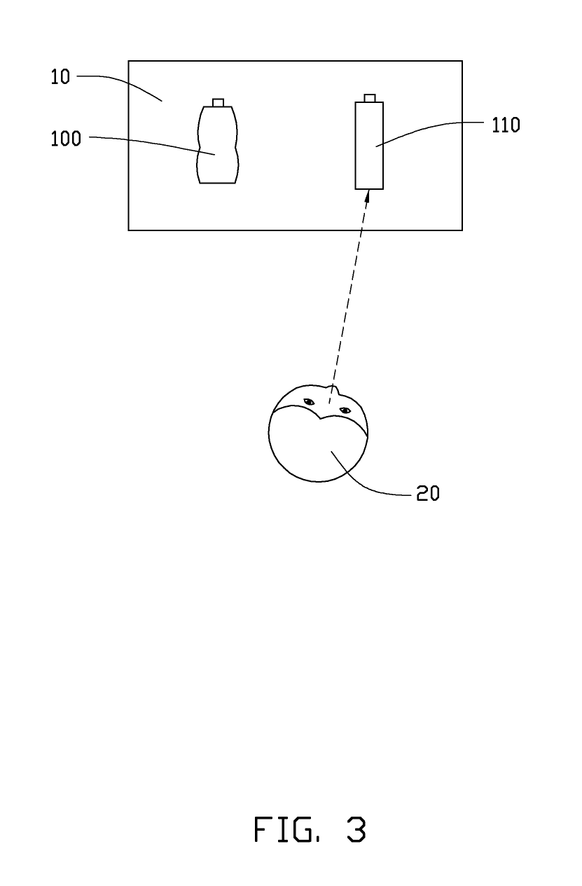

Referring to FIG. 3, the electronic billboard 10 displays two types of products. A first product 100 is displayed on a left side of the electronic billboard 10, which is called a first area. A second product 110 is displayed on a right side of the electronic billboard 10, which is called a second area. The media storing module 188 (FIG. 2) stores advertisements for the first product 100 and the second product 110. The advertisements for the first product 100 correspond to the first area. The advertisements for the second product 110 correspond to the second area.

The TOF camera 12 captures an image of the immediate area. The image comprises an individual 20 who is viewing the electronic billboard 10. The image is transmitted to the facial recognition module 180. According to the facial recognition module 180, the 3D model building module 182, the area determining module 185, and the time determining module 186, it can be obtained that the face of the individual 20 looks at the second area. The individual 20 is interesting in the second area.

The control module 187 selects the advertisements for the second product 110 correspondingly. The selected media content is displayed by the electronic billboard 10.

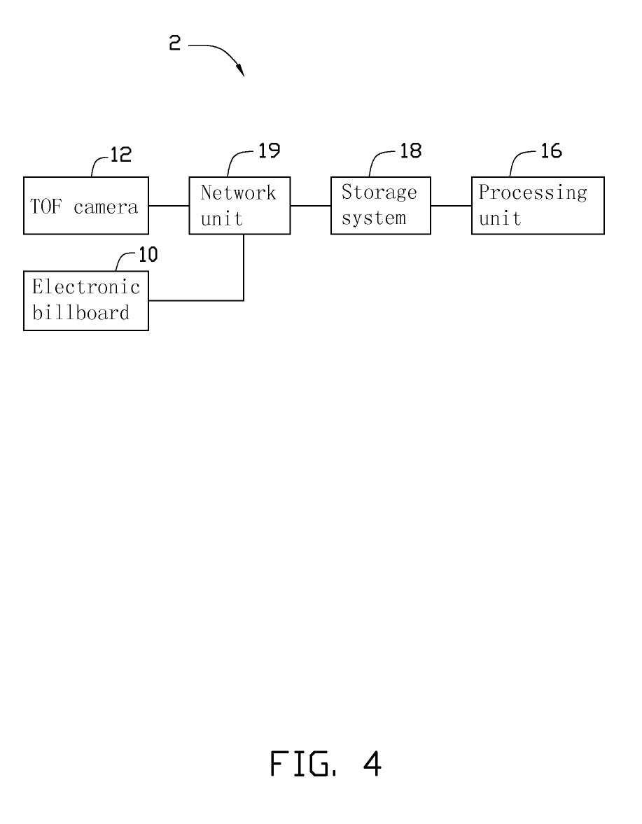

Referring to FIG. 4, a second embodiment of a file selection system 2 includes an electronic billboard 10, a time-of-flight (TOF) camera 12, a processing unit 16, a storage system 18, and a network unit 19. The electronic billboard 10, the TOF camera 12, the processing unit 16, and the storage system 18 are the same with the first embodiment. The network unit 19 is operable to transmit images between the storage system 18 and the TOF camera 12, and media content between the storage system 18 and the electronic billboard 10.

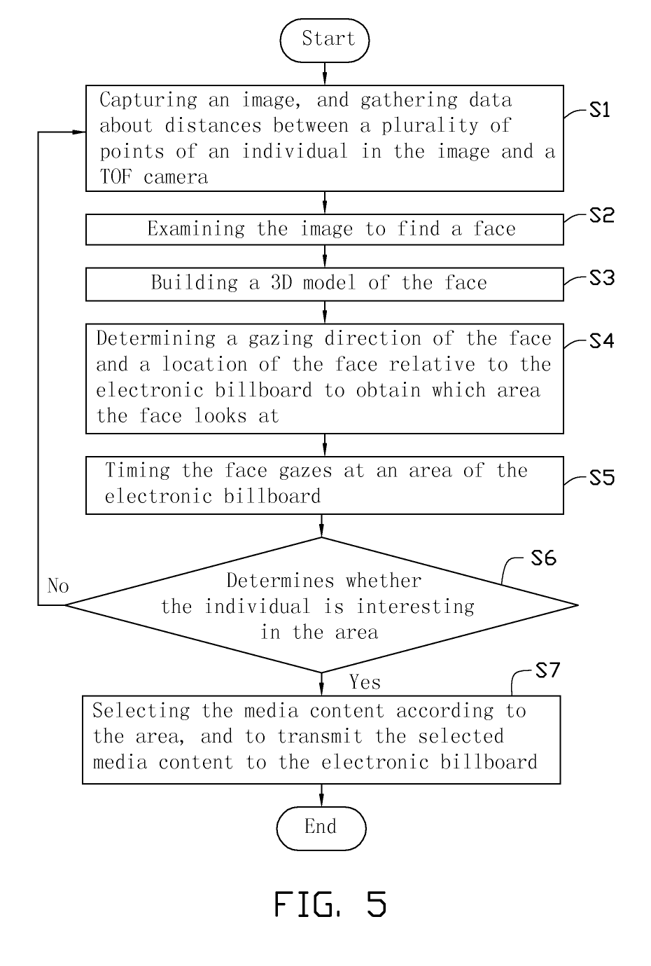

Referring to FIG. 5, an exemplary embodiment of a file selection method includes the following steps.

In step S1, the TOF camera 12 captures an image of the immediate area. The TOF camera 12 further gathers data about distances between a plurality of points of an individual in the image and the TOF camera 12. The TOF camera 12 is a camera system that gathers data about distances between the plurality of points of the audience members and the TOF camera 12. When the TOF camera 12 is recording the individual, the TOF camera 12 emits signals to the individual. The signals are reflected back to the TOF camera 12 when the signals meet a feature of an audience member, such as a nose. As a result, the data about distances can be obtained according to time differences between sending and receiving the signals of the TOF camera 12.

In step S2, the facial recognition module 180 examines the image from the TOF camera 12 to find a face. It can be understood that the facial recognition module 180 uses well known facial recognition technology to find the face.

In step S3, the 3D model building module 182 builds a 3D model of the face according to the image and the data about distances between a plurality of points of the audience members and the TOF camera 12. In the embodiment, according to the data about distances between the plurality of points of the audience members and the TOF camera 12, the plurality of points of the audience members have coordinates relative to the TOF camera 12. The 3D model building module 182 can obtain a 3D mathematical model according to the coordinates of the plurality of points and the image. The 3D mathematical model can be regarded as the 3D model of the face.

In step S4, the area determining module 185 determines a gazing direction of the face and a location of the face relative to the electronic billboard 10 according to the 3D model of the face, to obtain which area the individual looks at.

In step S5, the time determining module 186 times the individual gazing at an area of the electronic billboard 10. In the embodiment, the time determining module 156 starts to time when the individual begins to gaze at an area of the electronic billboard 10, and stops timing when the individual begins to gaze at another area of the electronic billboard 10. As a result, the time determining module 186 can time the individual gazing an area of the electronic billboard 10.

In step S6, the control module 187 determines whether the individual is interesting in the area according to the time from the time determining module 186.

In step S7, upon the condition that the individual is interesting in the area, the control module 187 selects the media content according to the area, and transmits the selected media content to the electronic billboard 10. The electronic billboard 10 displays the media content in the media storing module 188 according to the control module 187. Upon the condition that the individual is not interesting in the area, the process returns to the step S1.

The foregoing description of the exemplary embodiments of the disclosure has been presented only for the purposes of illustration and description and is not intended to be exhaustive or to limit the disclosure to the precise forms disclosed. Many modifications and variations are possible in light of the above everything. The embodiments were chosen and described in order to explain the principles of the disclosure and their practical application so as to enable others of ordinary skill in the art to utilize the disclosure and various embodiments and with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A file selection system comprising:
a time-of-flight (TOF) camera to capture an image and obtain data about distances between a plurality of points of an individual in the image and the TOF camera;
a display unit;
a processing unit; and
a storage system connected to the processing unit and storing a plurality of programs to be executed by the processing unit, wherein the storage system comprises:
a facial recognition module to examine the image from the TOF camera to find a face;
a three dimension (3D) building module to build a 3D model of the face of the audience according to the image of the individual and the data about distances between the plurality of points of the individual and the TOF camera;
an area determining module to determine a gazing direction of the face and a location of the face relative to the display unit according to the 3D model of the face of the individual, to obtain which area the face looks at;
a storing module storing a plurality of different media content and a plurality of relationships between different area the face looks at and the different media contents;
a time determining module timing the face looks at the area; and
a control module to determine whether the individual is interesting in the area according to a time from the time determining module, and select the media content correspondingly upon the condition that the individual is interesting in the area, thereby displaying the selected media content by the display unit.

2. The file selection system of claim 1, wherein a 3D coordinate relative to the TOF camera of each point of the plurality of points is obtained, and the 3D model building module builds a 3D mathematical model as the current 3D model of the face according to the 3D coordinates.

3. The file selection system of claim 1, wherein the storing module comprises:
a media storing module storing the plurality of different media contents; and
a relationship storing module storing the plurality of relationships between the different areas the individual looks at and the different media contents.

4. The file selection system of claim 1, further comprising a network unit to transmit the images between the storage system and the TOF camera, and transmit the media content between the storage system and the display unit.

5. The file selection system of claim 1, wherein the display unit is an electronic billboard.

6. A file selection method comprising:
capturing an image, and obtaining data about distances between a plurality of points of an individual in the image and a time-of-flight (TOF) camera by the TOF camera;
examining the image from the TOF camera to find a face;
building a three dimension (3D) model of the face of the individual according to the image and the data about distances between the plurality of points of the individual and the TOF camera;
determining a gazing direction of the face and a location of the face relative to a display unit according to the 3D model of the face of the individual, to obtain which area the face looks at;
selecting a media content according to the area the face looks at; and
displaying the selected media content by the display unit.

7. The file selection method of claim 6, after the step of “determining a gazing direction of the face and a location of the face relative to a display unit according to the 3D model of the face of the individual, to obtain which area the face looks at”, further comprises:
calculating a time the face gazes at an area of the display unit; and
determining whether the individual is interesting in the area;
wherein upon the condition that the individual is interesting in the area, the step of selecting a media content according to the area the face looks at is executed.

8. The file selection method of claim 6, after the step of “determining a gazing direction of the face and a location of the face relative to a display unit according to the 3D model of the face of the individual, to obtain which area the face looks at”, further comprises:
calculating a time the face gazes at an area of the display unit; and
determining whether the individual is interesting in the area;
wherein upon the condition that the individual is not interesting in the area, the step of “capturing an image, and obtaining data distances between a plurality of points of an individual and a TOF camera by the TOF camera” is executed.

9. The file selection method of claim 6, wherein the step of “building a 3D model of the face of the individual” comprises:
obtaining a 3D coordinate relative to the TOF camera of each point of the plurality of points; and
building a 3D mathematical model as the 3D model of the face according to the 3D coordinates.

10. The file selection method of claim 6, wherein the display unit is an electronic billboard.
